(19) United States
(12) Patent Application Publication
(10) Pub. No.: US 2020/0167717 A1
(43) Pub. Date: May 28, 2020

(54) SYSTEMS AND METHODS FOR OUTPUTTING RESOURCE ALLOCATION RECORDS

(71) Applicant: ServiceNow, Inc., Santa Clara, CA (US)

(72) Inventor: Robert Anderson, Redwood City, CA (US)

(21) Appl. No.: 16/201,721

(22) Filed: Nov. 27, 2018

(51) Int. Cl. G06Q 10/06; G06F 16/248

(52) U.S. Cl. CPC G06Q 10/063118; G06F 16/248

(57) ABSTRACT

The present approach relates generally to systems and methods for generating a resource allocation record with a client instance hosted by one or more data centers, wherein the client instance is accessible by one or more remote client networks. In accordance with the present approach, a rate request that includes a resource time range and one or more resource attributes is received and, in response, a resource table is retrieved. Further, candidate records from the resource table are identified based on a comparison between the resource plan time range and the resource availability data of each record. Further still, a subset of the candidate records is identified based on a comparison between the resource attributes of the rate request. Even further, one or more resource allocation records are outputting based on the resource plan time range and a rate of at least one of the subset of candidate records.

### BACKGROUND

The present disclosure relates generally to outputting allocation records based on date-effective hourly rates for a specific set of criteria related to a project, demand, or time card being processed.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Enterprises or organizations may perform certain operations having certain timelines, such as software projects or other types of development projects. A project and/or resource manager may be tasked with allocating resources (e.g., assigning employees or groups of employees) to perform the project within the timeline. A further consideration in the allocation of resources is cost of the allocation of resources, which is generally determined by a rate associated with the resource and the amount of time to be worked over the timeline. As the enterprise or organization may operate in different locations (e.g., cities, states, countries) with various departments (e.g., financial, database management, information technology, and so forth) and members of each department having different roles (e.g., managers, assistants, associates, and so forth) each having different rates (e.g., billing rates), coordination of the allocation of resources can be a difficult task.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present approach relates generally to systems and methods for generating resource allocation records based on a rate request received by a computer, which may in some embodiments be communicatively coupled to a cloud computing environment. The systems and methods disclosed herein receive a rate request that includes a resource time range and one or more resource attributes. The computer may then retrieve a resource table that includes multiple resource records, which each have multiple fields containing data indicative of an availability of a resource, a rate of the resource, and attributes of the resource. Then, the computer may a identify one or more candidate records from the resource table based at least in part on a comparison between the resource plan time range of the rate request and the resource availability data of each record. Further, the computing system may identify a subset of the one or more candidate records based at least in part on a comparison between the one or more resource attributes of the rate request. In some embodiments, the computing system may determine that none of the resource records have the resource attributes from the rate request and, thus, output a default rate or use a rate from a resource record have an “all-other” attribute, as discussed herein. Further still, the computing device may output one or more resource allocation records based at least in part on the resource plan time range and a rate of at least one of the subset of candidate records.

### BRIEF DESCRIPTION OF THE DRAWINGS

Various aspects of this disclosure may be better understood upon reading the following detailed description and upon reference to the drawings in which:

FIG. 1 is a block diagram of an embodiment of a cloud architecture in which embodiments of the present disclosure may operate;

FIG. 2 is a schematic diagram of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a flow diagram for outputting resource allocation records using a rate model based on a received request, in accordance with aspects of the present disclosure;

FIG. 5 is a block diagram for identifying candidate records and one or more subsets of candidate records, in accordance with the present disclosure;

FIG. 6 is a resource table from a database, in accordance with the present disclosure;

FIG. 7 is a resource table from the database with a first request and a first identified candidate record, in accordance with the present disclosure;

FIG. 8 is a resource table from the database with a second request and a second identified candidate record, in accordance with the present disclosure;

FIG. 9 is a resource table from the database with a third request and two identified candidate records, in accordance with the present disclosure;

FIG. 10 shows four resource allocations records generated based on the two identified candidate records shown in FIG. 9, in accordance with the present disclosure;

FIG. 11 shows the four resource allocations records shown in FIG. 10 that were generated based on the two identified candidate records shown in FIG. 9, in accordance with the present disclosure;

FIG. 12 shows an identified candidate record that includes an “all-others” attribute in at least one field, in accordance with aspects of the present disclosure;

FIG. 13 shows a second identified candidate record that includes an “all-others” attribute in at least one field, in accordance with aspects of the present disclosure;

FIG. 14 is a screenshot of an embodiment of a rate request interface to determine a rate model, in accordance with aspects of the present disclosure;

FIG. 15 is a screenshot of an additional embodiment of a rate request interface to determine a rate model, in accordance with aspects of the present disclosure;

FIG. 16 is a screenshot of an embodiment of a rate model setup interface, in accordance with aspects of the present disclosure;

FIG. 17 is a screenshot of an additional embodiment of the rate model setup interface shown in FIG. 16, in accordance with aspects of the present disclosure; and

FIG. 18 is a screenshot of an additional embodiment of the rate model setup interface shown in FIG. 16, in accordance with aspects of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

As discussed herein, employing a computing system that is communicatively coupled to databases storing resource records related to the resource availability (e.g., time and/or capacity), resource attributes (e.g., role, group, name of individuals, and so forth), and rates may allow the generation of accurate allocation records. For example, project managers may employ rate models to determine an optimal allocation of resources, from resource tables that may be stored within the databases, based on requested resource attributes and/or a requested time for completion. The rate models would retrieve date-effective and time-varying rates related to the project, a demand, and/or a time card being processed to provide accurate resource allocation records and, thus, improve the efficiency resource management within the enterprise.

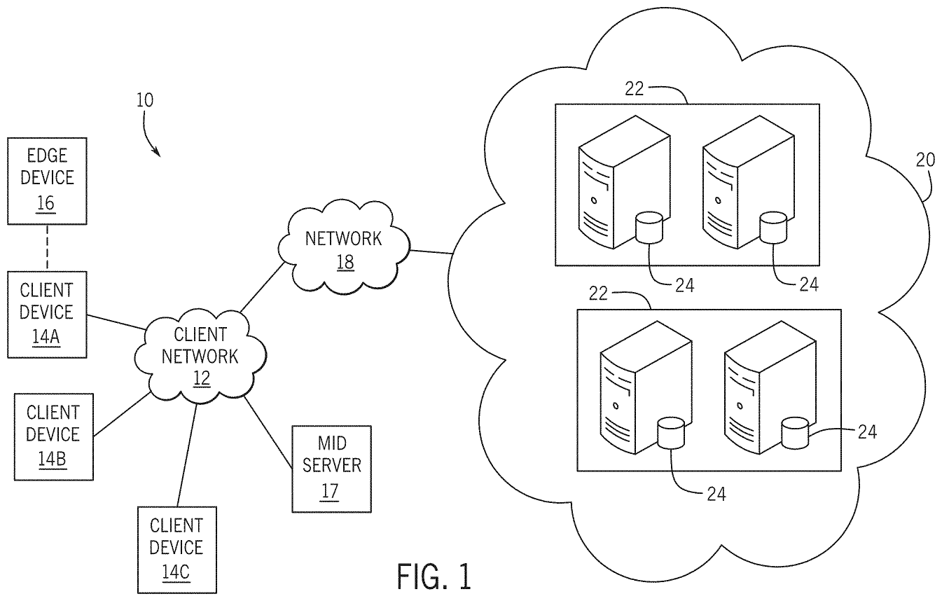

With the preceding in mind, the following figures relate to various types of generalized system architectures or configurations that may be employed to provide cloud-based services to an organization and on which the present approaches may be employed. Correspondingly, these system and platform examples may also relate to systems and platforms on which the techniques discussed herein may be implemented or otherwise utilized. Though a cloud-based computing environment is provided by way of one example of a suitable computing framework, it should be appreciated that the present approach may be implemented in other computing environments, including stand-alone computing environments as well as local networks without access to cloud-based resources. With this in mind, and turning to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In some implementations, the cloud-based platform 16 may be a configuration management database (CMDB) platform. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial device or server, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

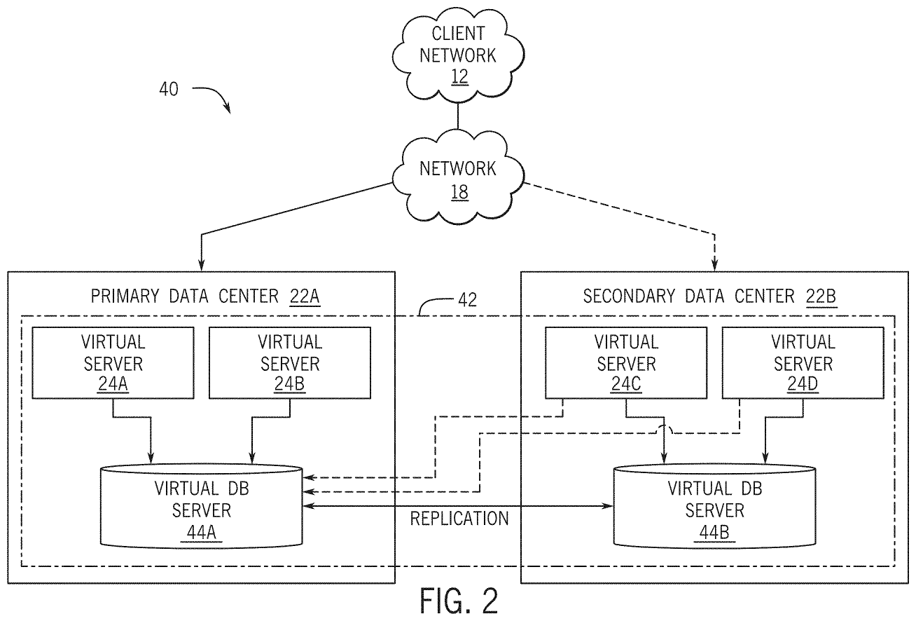

In another embodiment, one or more of the data centers 18 are configured using a multi-instance cloud architecture to provide every customer its own unique customer instance or instances. For example, a multi-instance cloud architecture could provide each customer instance with its own dedicated application server and dedicated database server. In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 40 where embodiments of the present disclosure may operate. FIG. 2 illustrates that the multi-instance cloud architecture 40 includes the client network 12 and the network 18 that connect to two (e.g., paired) data centers 22A and 22B that may be geographically separated from one another. Using FIG. 2 as an example, network environment and service provider cloud infrastructure client instance 42 (also referred to herein as a client instance 42) is associated with (e.g., supported and enabled by) dedicated virtual servers (e.g., virtual servers 24A, 24B, 24C, and 24D) and dedicated database servers (e.g., virtual database servers 44A and 44B). Stated another way, the virtual servers 24A-24D and virtual database servers 44A and 44B are not shared with other client instances and are specific to the respective client instance 42. In the depicted example, to facilitate availability of the client instance 42, the virtual servers 24A-24D and virtual database servers 44A and 44B are allocated to two different data centers 22A and 22B so that one of the data centers 22 acts as a backup data center. Other embodiments of the multi-instance cloud architecture 40 could include other types of dedicated virtual servers, such as a web server. For example, the client instance 42 could be associated with (e.g., supported and enabled by) the dedicated virtual servers 24A-24D, dedicated virtual database servers 44A and 44B, and additional dedicated virtual web servers (not shown in FIG. 2).

Although FIGS. 1 and 2 illustrate specific embodiments of a cloud computing system 10 and a multi-instance cloud architecture 100, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

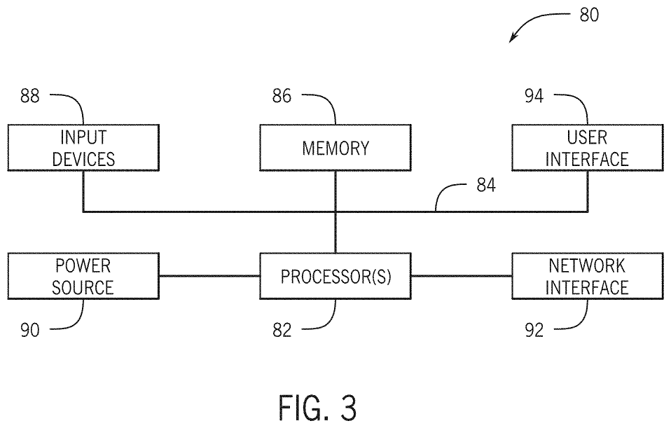

With this in mind, and by way of background, it may be appreciated that the present approach may be implemented using one or more processor-based systems such as shown in FIG. 3. Likewise, applications and/or databases utilized in the present approach stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, and by way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3 and may be present in the embodiments of FIGS. 1 and 2. FIG. 3 generally illustrates a block diagram of example components of a computing system 80 and their potential interconnections or communication paths, such as along one or more busses 84. As illustrated, the computing system 80 may include various hardware components such as, but not limited to, one or more processors 82, one or more busses 84, memory 86, input devices 88, a power source 90, a network interface 92, a user interface 94, and/or other computer components useful in performing the functions described herein. The one or more processors 82 may include one or more microprocessors capable of performing instructions stored in the memory 86. Additionally or alternatively, the one or more processors 82 may include application-specific integrated circuits (ASICs), field-programmable gate arrays (FPGAs), and/or other devices designed to perform some or all of the functions discussed herein without calling instructions from the memory 86.

With respect to other components, the one or more busses 84 includes suitable electrical channels to provide data and/or power between the various components of the computing system 80. The memory 86 may include any tangible, non-transitory, and computer-readable storage media. Although shown as a single block in FIG. 1, the memory 86 can be implemented using multiple physical units of the same or different types in one or more physical locations. The input devices 88 correspond to structures to input data and/or commands to the one or more processor 82. For example, the input devices 88 may include a mouse, touchpad, touchscreen, keyboard and the like. The power source 90 can be any suitable source for power of the various components of the computing system 80, such as line power and/or a battery source. The network interface 92 includes one or more transceivers capable of communicating with other devices over one or more networks (e.g., a communication channel). The network interface 92 may provide a wired network interface or a wireless network interface. A user interface 94 may include a display that is configured to display text or images transferred to it from the one or more processors 82. In addition and/or alternative to the display, the user interface 94 may include other devices for interfacing with a user, such as lights (e.g., LEDs), speakers, and the like.

With the preceding in mind, a user (e.g., a project manager) may manage a project, such as a software development project or other type of project, using computing resources such as those described above. As part of such project management, the user may submit a rate request on a client device 14 to produce a resource allocation record for an enterprise operation, such as a project. For example, the rate request may be submitted in response to a project, a task, a resource, a resource plan, or time card. A rate model identifies data from rate request (e.g., resource time range and attributes) that correspond to characteristics specified on the rate model. More specifically, the rate model iteratively filters records (e.g., dismisses records that do not match the attributes and/or resource time range data) from a resource table based on comparison between data in the rate request and data in one or more fields of the resource table. Each record that is filtered out of the resource table is generally referred to herein as a “candidate row” or a “subset of the candidate row.” The candidate rows are then used to generate a resource allocation record.

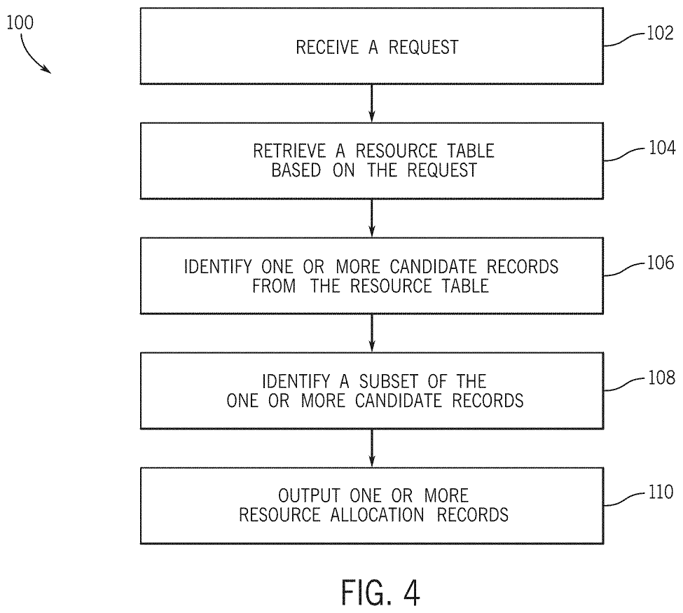

FIG. 4 is a flow diagram 100 for generating resource allocation records based on a received rate request using a rate model, in accordance with aspects of the present disclosure. The steps illustrated in the flow diagram 100 may be performed or displayed on the client devices 14 operated by a client (e.g., on a client instance) on the network 12 or on other suitable devices present on the cloud computing system 10 and operated by users of the client network 12. Furthermore, the steps illustrated in the flow diagram 100 are meant to facilitate discussion and are not intended to limit the scope of this disclosure, since additional steps may be performed, certain steps may be omitted, and the illustrated steps may be performed in any order.

The flow diagram 100 may include (process block 102) receiving a rate request having a resource plan time range (e.g., a time range for a task to be completed) and one or more resource attributes. The resource attributes may relate to a group (e.g., analysts, administrators, etc.), within the enterprise, a location (e.g., city, state, country) of the group, a type of currency (e.g., dollars, pounds, yen), a person within the enterprise, or any combination thereof. In some embodiments, the request may submitted by an operator via interaction such as clicking an interactive element (e.g., a button on a web-portal or similar interface) displayed on a user interface 94.

After receiving the rate request (block 102), the computing system 10 may retrieve a resource table from one or more databases (process block 104). In a project management context, the resource table may have multiple records (e.g., resource records), and each resource record may have multiple fields that each contain data indicative of the attributes of the resource, such as the rate of the resource and the availability. After retrieving the resource table from the one or more databases, the computing system 10 may identify (process block 106) one or more candidate records based on a comparison between the resource plan time range and resource availability data in the fields of each record of the resource table.

After identifying one or more candidate records, the computing system may identify (process block 108) a subset of the one or more candidate records. For example, a subset of the candidate records may be identified based at least on a comparison between the resource attributes of the rate request and the resource attribute data of the one or more candidate records that were previously identified (process block 106). In the context of resource attributes, the comparison may include determining whether the resource attribute data in the fields of the one or more candidate records match the resource attributes of the rate request and flagging or identifying that subset of the one or more candidate records. After identifying the subset of the one or more candidate records, the computing system may output one or more resource allocation records (process block 110). In some embodiments, the resource allocation records may be outputted on a display, such as the user interface 94.

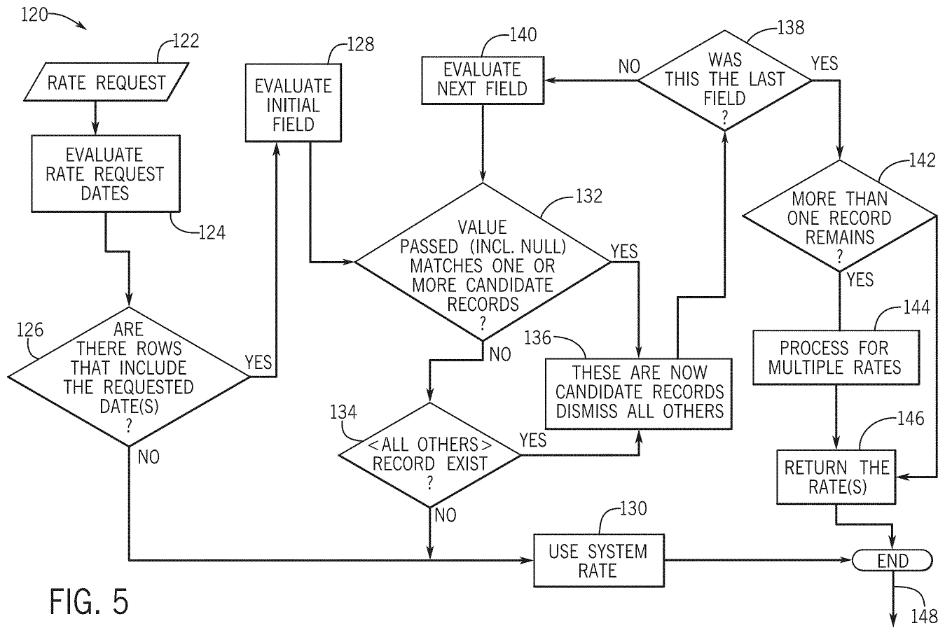

With the foregoing in mind, FIG. 5 is a block diagram 120 depicting an operation of a rate model that identifies candidate records (process block 106) and/or identifies one or more subsets of candidate records (process block 108), in accordance with the present disclosure. It should be appreciated that the block diagram 120 is meant to be an illustrative and non-limiting example of one approach to identifying candidate records, as discussed herein.

As discussed herein, the computing system 10 may receive (process block 102) a rate request and, in response, retrieve (process block 104) a resource table from the database 44. Then, the client instance may evaluate (process block 124) the resource plan time range (e.g., a start date and an end date) and one or more attributes (e.g., an attribute related to a location, group, and/or role within an enterprise). As such, evaluating the rate request may relate to determining what data and what the data relates to (e.g., a time range, attributes, rates) so that an appropriate resource table may be retrieved, for example. In some embodiments, the time range of the rate request may be evaluated (e.g., compared to time range data in the resource allocation record) before the attributes date; however, in other embodiments, the one or more attributes may be evaluated before the time range.

Then, the computing system 10 may determine (process block 126) if there are resource records that include (e.g., at least partially overlap) the time range in one or more fields of the resource records. If there are one or more resource records that include the time range, then those one or more resource records are identified as candidate records. Then, a first field of the candidate records is evaluated (process block 128). In some embodiments, the first field that is evaluated may be predetermined by an administrator. If there are no fields within the resource record that at least partially overlap with a time range included in the rate request, then the client instance 20 may output (process block 130) a system default resource (e.g., default rate). The default rate may be predetermined by an administrator or by the project manager, for example.

Referring back to evaluating (process block 128) the first field, the computing system 10 determines (process block 132) if the first field matches the resource attribute of the rate request. If one or more of the candidate records (i.e., more specifically, the field of the candidate record) include the resource attribute then the computing system 10 identifies a subset of the original candidate records as the candidate records (process block 136). If none of the candidate records include the resource attribute, then the computing system 10 determines if any of the candidate records include an “all-others” attribute in the field (process block 134). In general, a record having an “all-others” attribute should be used if no other records have an attribute in the field that matches the attribute being searched for. If at least one “all-others” record exists, then that row is identified as the candidate record (process block 136). If not, then the computing system 10 uses a default record (process block 130).

After identifying a candidate record (process block 136) based on a first attribute, the computing system 10 determines if there are other fields in the resource record to check (process block 138). In some embodiments, this may involve determining if there are additional attributes in the rate request, if so, the next field is evaluated (process block 140), which may dismiss some of the candidate rows from the previously identified candidate rows. It should be appreciated that the process may then continue with process block 132 until there are no remaining fields (process block 138).

When there are no remaining fields (process block 138), the computing system 10 may determine if more than one candidate record remains (process block 142). If more than one candidate record remains, the multiple candidate rows are process (process block 144) for multiple rates. For example, the two identified candidate records may each partially overlap with the time range request from the rate request and, thus, both candidate records may be selected and the rates for each selected candidate rate over the time range that partially overlaps with the time range request are used. That is, the rates of the remaining candidate records are then returned (process block 146) for outputting a resource allocation record as discussed herein, and then the block diagram 120 may repeat for multiple rate requests (arrow 148). In some embodiments, the multiple rates may relate to a first rate (e.g., a standard rate) and a second rate (e.g., an overtime rate).

To further help illustrate the steps in the flow diagram 100 and the block diagram 120 of FIGS. 4 and 5, FIGS. 6-13 generally show at least one of a resource table, a rate request, candidate records, and an allocation record. As discussed above, the flow diagram 100 and block diagram 120 may involve iterating through comparisons between the attributes of the rate request and the attributes in the fields of the resource table. For example, one or more candidate rows may be identified based on a first comparison between an attribute in a rate request and an attribute in a field of the resource records. Then, when there is a second attribute in the rate request, a subset of candidate rows is identified based on a second comparison between a second attribute in a rate request and a second attribute in a field of the resource records. It should be appreciated that this process may be repeated if there are additional attributes. Rather than referring to each subset of candidate rows as “a first subset”, “a second subset”, and “so forth”, the candidate row identified based on the most recent comparison may simply be referred to as the candidate row.

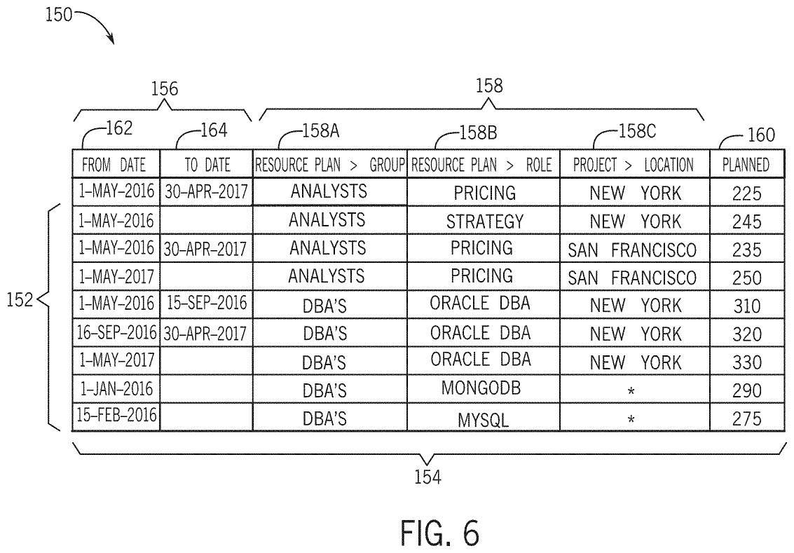

FIG. 6 is a resource table 150 from the database 44, in accordance with the present disclosure. As discussed herein, the resource table 150 may include multiple records 152 (e.g., shown as the rows of the resource table 150 in this example) having multiple fields 154 (e.g., shown as the columns of the resource table 150 in this example). Generally, the fields 154 may include time range fields 156 having resource availability data, resource attribute fields 158 having resource attribute data, and a rate field (e.g., planned rate 160) having rate data. The time range fields 156 may include a start date (e.g., ‘from data’) field 162 and an end date (e.g., ‘to date’) field 164. It should be appreciated that an empty end date 164 may mean that the associated resource is available and it not tasked with any projects or tasks after the start date 162. As illustrated, the resource table 150 includes three attribute fields 158a, 158b, and 158c that contain resource attribute data (e.g., data indicative of the resource's group, role, and location) related to a respective resource record 152. As illustrated, the resource table 150 includes a planned rate 160. While only a single rate is shown in the illustrated embodiment of the resource table 150, in some embodiments, the resource table 150 may include additional rate fields.

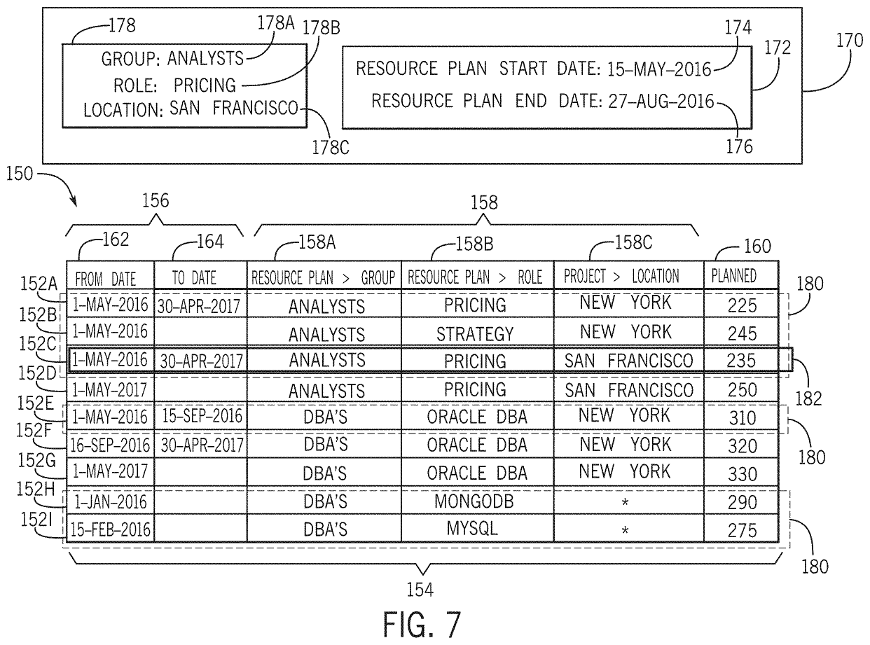

FIG. 7 shows the resource table 150 from the database 44 with a first request 170, in accordance with the present disclosure. As illustrated, the first request 170 includes a resource plan time range 172 having a start date 174 and an end date 176, and multiple resource attributes 178 (e.g., 178a, 178b, and 178c).

As discussed herein, one or more candidate records may be identified based on a comparison between the resource plan time range 172 of the rate request 170 and the data stored in the time range fields 156. As illustrated, the resource plan time range 172 has a start date 174 of ‘15-May-2016’ and an end date 176 of ‘27-Aug-2016’. The candidate records from 152 from the resource table 150 that overlap with the resource plan time range 172 are resource record 152a, 152b, 152c, 152d, 152f, 152h, and 152i and, thus, are the identified candidate records. It should be appreciated that the time range field 156 of the resource record 152f partially overlaps with the resource time range 172 of the rate request 170 and, in some embodiments, may be identified as a candidate record.

Continuing with the process illustrated in FIGS. 4 and 5 as applied to the resource table 150 shown in FIG. 7, the next step is determining a subset of the candidate records based on a comparison between the resource attributes 158 of each of the candidate records (e.g., 152a, 152b, 152c, 152f, 152h, and 152i) from the resource table 150 and the resource attributes 178 of the rate request 170. The order of which of the resource attributes 178 to compare first may be decided by an administrator or operator for optimal efficiency. For example, comparing the resource attribute 178a reduces (e.g., identifies a subset) the candidate records to resource records 152a, 152b, and 152c, while comparing the resource attribute 178c first reduces the candidate records to resource record 152c. As illustrated, only resource record 152c has resource attribute data 158 that match the resource attributes 178 of the rate request 170 and, thus, identifying a subset of the candidate records 180 beginning with 178a would be less efficient in this illustrated non-limiting example. As discussed in further detail below, the identified subset of the candidate record 182 (e.g., resource record 152c) may then be used for outputting a resource allocation record.

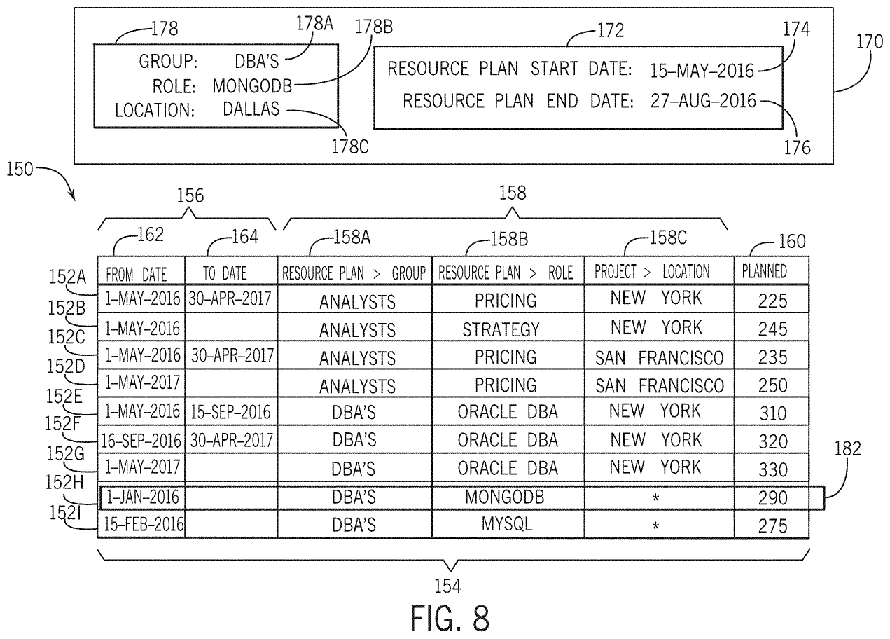

As an additional non-limiting illustrative example of the processes 100 and 120, FIG. 8 is a resource table from the database 44 with a second request 170, in accordance with the present disclosure. In some embodiments, none of the resource attributes 158 of the resource records 152 may match a resource attribute 178 of the rate request 170. In particular, the resource attribute 178c does not match any of the resource attribute data 158c of the resource records 152. In such a case, it may be advantageous to assign an “all-else” attribute to one or multiple of the resource records 152 such that a suitable resource record 152 may be identified as a candidate. As illustrated, resource record 152 is the subset of the candidate records 182 based on application of the process 100, as described herein.

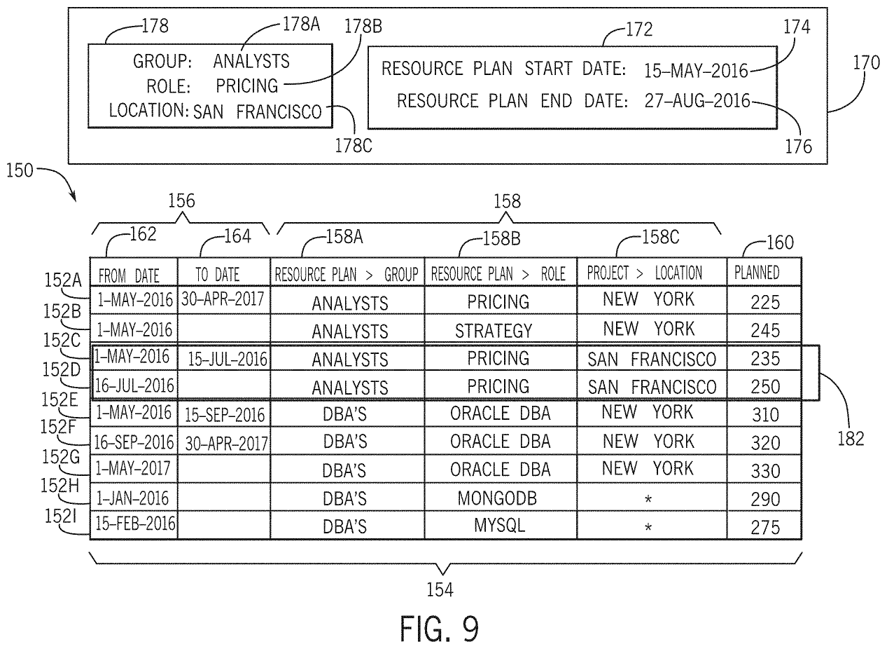

As a further non-limiting example of the process 100 and block diagram 120, FIG. 9 is a resource table from the database 44 with a third request 170 and two identified candidate records, in accordance with the present disclosure. In this example, two resource records 152c and 152d have resource attributes 158 that match the resource attributes 178 of the rate request 170. The each time range field 156 of the resource records 152c and 152d only partially overlap with the resource plan time range 172 of the rate request 170; however, the combination of the time range fields 156 of the resource records 152c and 152d does overlap with the resource time range 172 of the rate request 170. Thus, in this non-limiting example, the subset of candidate records 182 includes both resource records 152c and 152d.

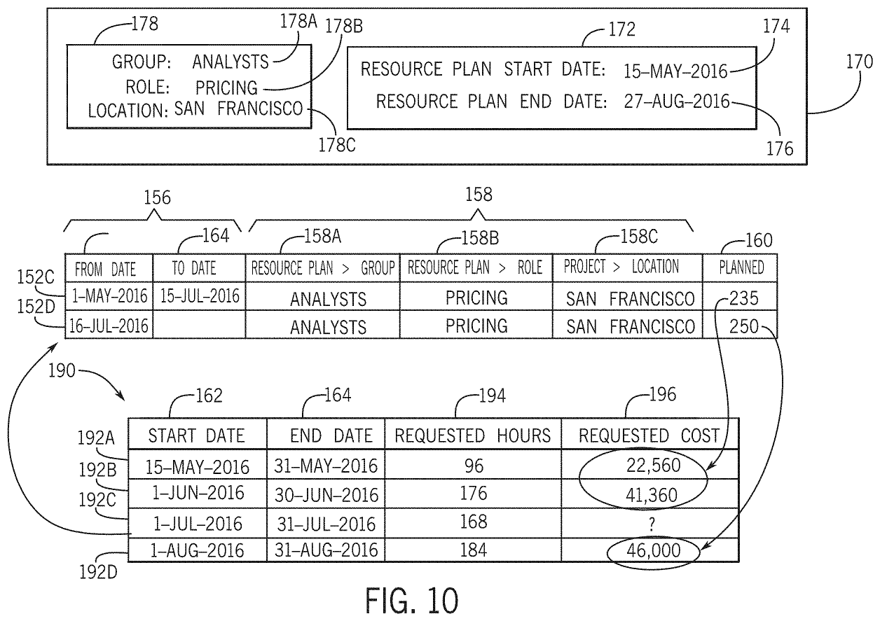

FIG. 10 shows a resource allocation table 190 with four resource allocation records 192 that were generated based on the two identified candidate records shown in FIG. 9, in accordance with the present disclosure. As discussed above, with respect to FIG. 9, the time field ranges of the resource records 152c and 152d each overlap with a portion of the resource time range 172. Therefore, both resource records 152c and 152d may be used to generate the resource allocation records 192 shown in the resource allocation table 190.

As shown, each resource allocation record has multiple fields: start date 162, a start date 164, a number of request hours field 194, and a requested cost field 196. It should be appreciated that additional fields may be included such as the type of currency. As such, the resource table 150 may be filtered based on the currency. Additionally, the requested cost may be based on the actual cost and the billing cost, which may be relevant for generating time cards. The start date 162 and the start date 164 of the resource allocation records 192 may be based on certain financial periods of the enterprise, such as, annually, semi-annual, quarterly, monthly, weekly, or other divisions of time. As illustrated, the start date 162 and end dates field 164 correspond to months and portions of months that overlap with the resource time range 172. The requested hours 194 generally corresponds to a number of billable hours during the time period (e.g., from start date 162 to start date 164 of the resource record 192). In some embodiments, the time period may factor in holidays. For example, as illustrated the data (e.g., numerical data ‘184’) in the requested hours field 194 of resource allocation record 192d is greater than the request hours 194 of resource allocation records 192c, which may be due to a holiday. Further, each resource allocation record 192 has a respective requested cost 196 that generally is the product of the planned cost 160 and the number of billable days in between the start date and the start date for a respective resource allocation record 192. For example, the requested cost 196 of the resource allocation record 192a is based on the planned cost 160.

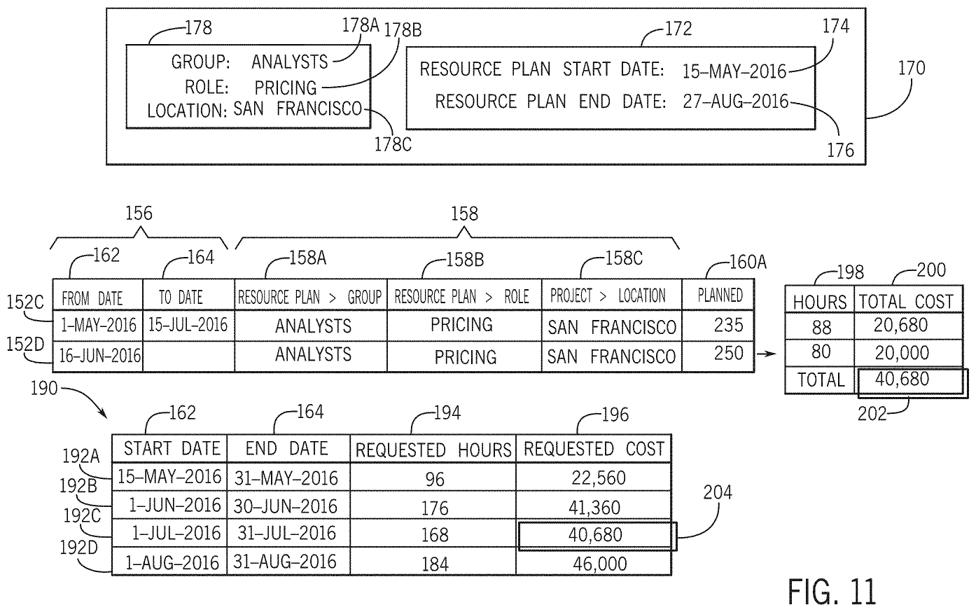

In some embodiments, the start date 162 and the start date 164 of a resource allocation record 192 overlap two different resource records 152. FIG. 11 shows resource allocation records 192 with one resource allocation record 192d that was generated based on two resource records (e.g., 152c and 152d), in accordance with the present disclosure. In particular, approximately half of the start date 162 and the end date 164 of resource allocation record 192c overlaps with the start date 162 and end date 164 of resource record 152c, while approximately another half of the start date 162 and the end date 164 of resource allocation record 192c overlaps with the start date 162 and end date 164 of resource record 152d. The division of hours 198 for each resource record 152c and 152d and the corresponding calculated cost 200 are also illustrated. Additionally, a total cost 202 is shown that is the sum of the cost 200 for each resource record 152c and 152d. As such, the requested cost 196 of the resource allocation record 192d (e.g., in field 204) is generated based on the planned costs 160 and the overlapping dates of a respective resource records 152c and 152d.

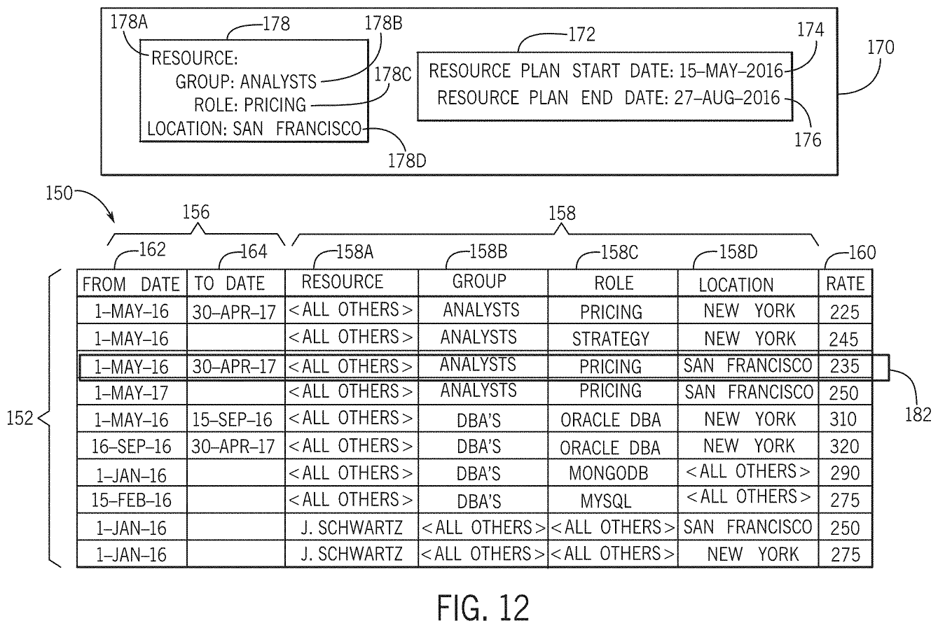

A project manager of an enterprise may not know who will perform an enterprise operation (e.g., a project) until the resource has been confirmed. As such, it is presently recognized that including an “all-others” designation within a field of a resource record may facilitate the generation of resource records when not all of the resource information is known. For example, FIG. 12 a rate request 170 having a blank resource attribute 178a and a candidate record 182 that is identified based on an “all-others” resource attribute data 158. As such, an “all-others” designation of a field may be used when not all resource attributes 178 of the rate request 170 are specified.

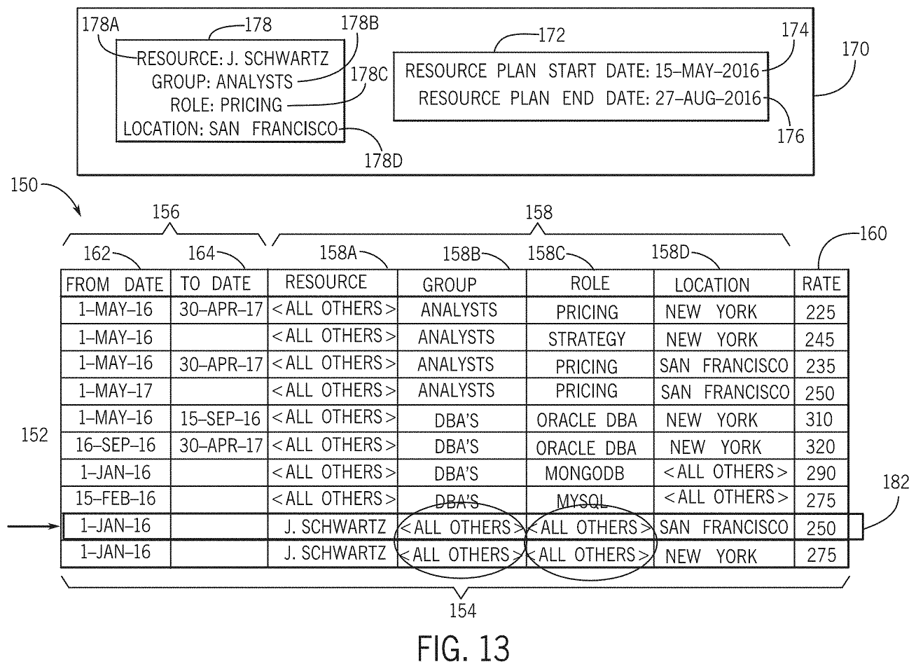

Additionally, an “all-others” designation may be used when none of the resource records 152 in the resource table 150 match the rate request. As shown in FIG. 13, the two candidate records 182 include the “all-others” designation in their group field 158b and role field 158c. Therefore, the client instance identifies the resource records 152 as candidate records 182 when the time range 156 of the resource records 152 overlaps the time range request 172. Further, the candidate records 182 include at least one resource attribute 158 that matches the resource attribute 178 of the rate request 170.

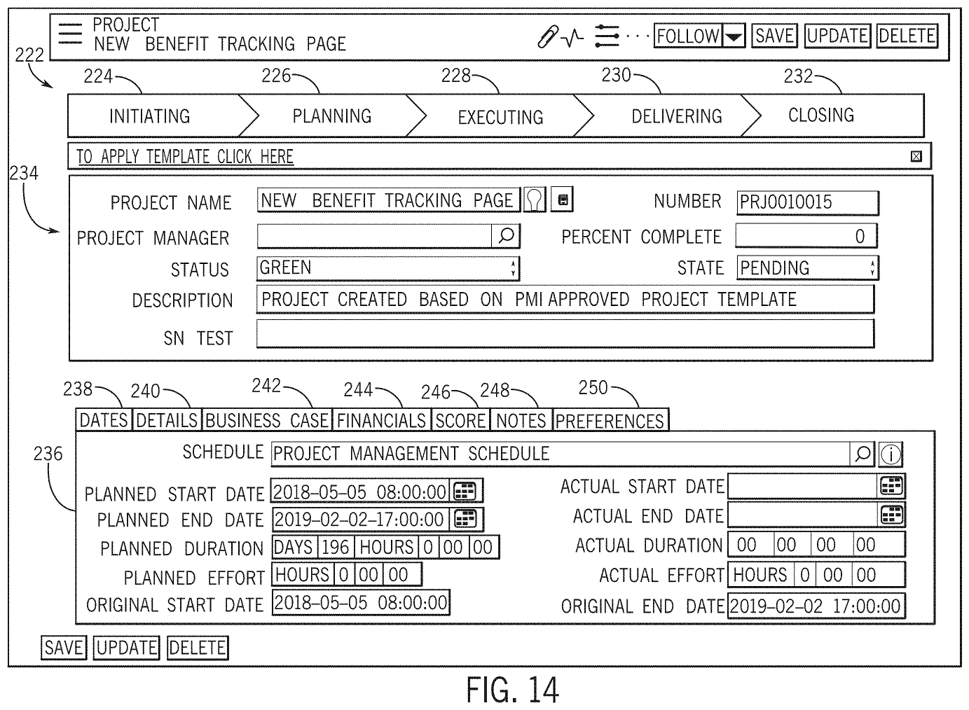

FIG. 14 is a screenshot of an example of a rate request interface 222 for submitting rate requests, in accordance with an embodiment of the present disclosure. In general, the rate request interface 222 may be used by project managers to determine a rate model for a project or demand. As illustrated, the rate request interface 222 includes progress tabs 224, 226, 228, 230, and 232 that generally represent the stage in a project (e.g., ‘initializing’, ‘planning’, ‘executing’, ‘delivering’, and ‘closing’). Further, the rate request interface 222 includes two input windows 234 and 236 that receive input from the project manager. The first input window 234 includes multiple fields that a user may interact with to organize the project. The second input window 236 includes multiple tabs 238, 240, 242, 244, 246, 248, and 250 that may each include multiple fields that the user may interact with to organize the project and/or input one or more resource attributes, a time range, and/or a budget for the project.

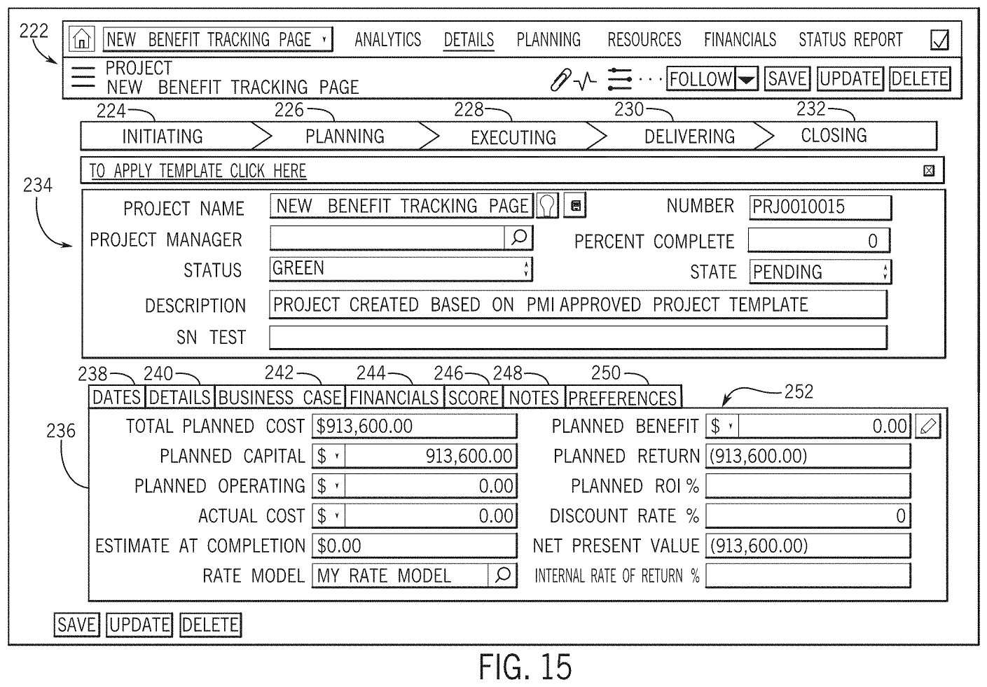

FIG. 15 is a screenshot of another example of a rate request interface 222 for submitting rate requests, in accordance with an embodiment of the present disclosure. As discussed herein, the rate request interface 222 may be used by project managers to determine a rate model for a project or demand. As illustrated, the rate request interface 222 includes the progress tabs 224, 226, 228, 230, and 232 that generally represent the stage in a project (e.g., ‘initializing’, ‘planning’, ‘executing’, ‘delivering’, and ‘closing’). Further, the rate request interface 222 includes two input windows 234 and 236 that receive input from the project manager. The first input window 234 includes multiple fields that a user may interact with to organize the project. The second input window 236 includes multiple tabs 238, 240, 242, 244, 246, 248, and 250 that may each include multiple fields that the user may interact with to organize the project and/or input one or more resource attributes, a time range, and/or a budget for the project.

The illustrated embodiment of the second input window 236 of the rate request interface 222 includes the financial window 252, which may be associated with the tab 244 (e.g., ‘financials’). In general, the financial window 252 includes multiple fields that a user may interact with to plan financial aspects for a project. As illustrated, such fields may include, but are not limited to, total planned cost, planned capital, planned operating cost, actual cost, estimated cost at completion, planned benefit, planned return, planned return on investment percentage (ROI %), discount rate percentage, net present value, internal rate of return percentage, and a rate model field 254. In some embodiments, the rate model field 254 may prompt a user to select a rate model (e.g., from a list of rate models) or search for a new rate model that may be used for planning the project, as discussed herein.

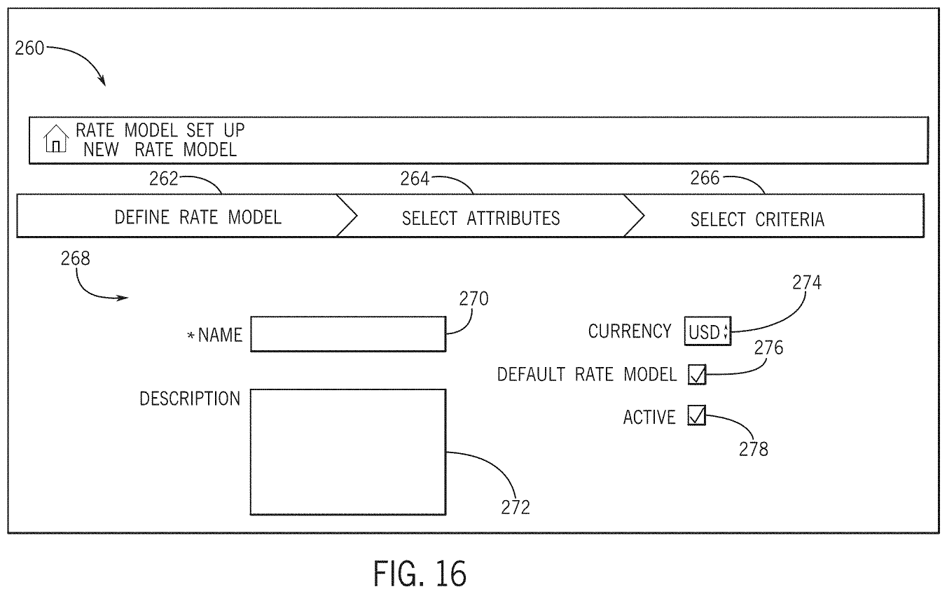

FIG. 16 is a screenshot of an embodiment of a rate model setup interface 260, in accordance with aspects of the present disclosure. In general, the rate model setup interface 260 may be used by administrators or project managers for creating and managing rate models. As illustrated, the rate model setup interface 260 includes progress tabs 262, 264, and 266 which may organize, and thus, facilitate the rate model setup process. For example, the progress tab 262 may have a corresponding window 268 that includes multiple fields 268 and 270 that a user may interact with to organize the project. Additionally, the window 268 may include one or multiple selectable features 274, 276, and 278. As illustrated, the selectable feature 274 may relate to a type of currency, the selectable feature 276 related to whether or not the rate model should be a default model, as discussed herein, and the selectable feature 278 may be an option for a user to say whether or not the rate model should be active.

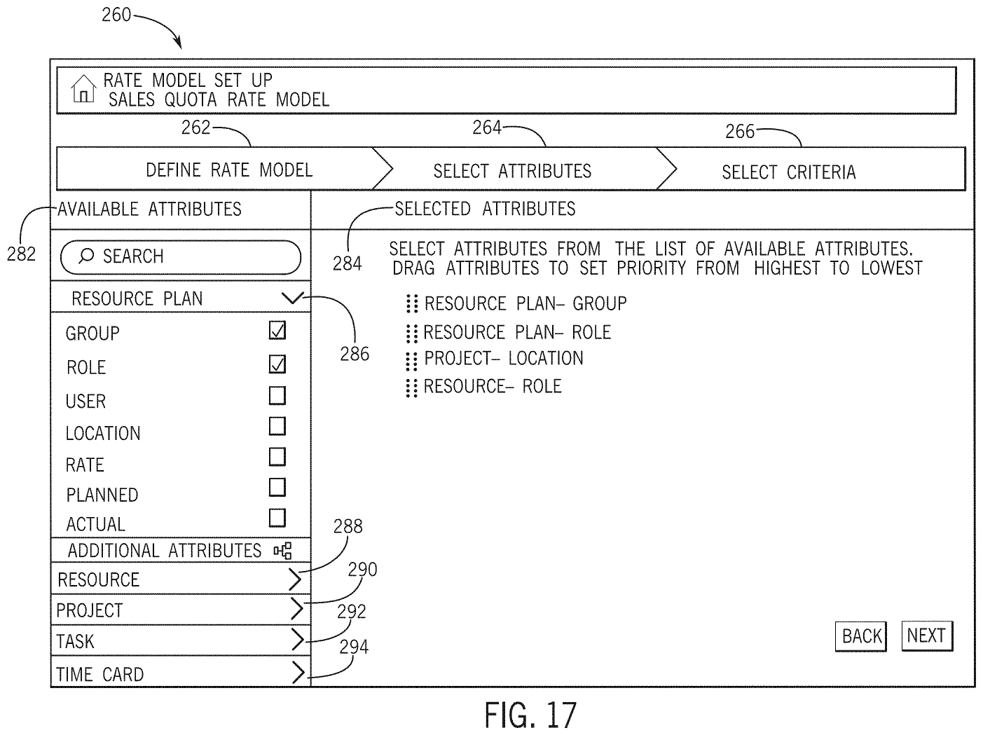

FIG. 17 is a screenshot of an additional embodiment of the rate model setup interface 260 shown in FIG. 16, in accordance with aspects of the present disclosure. As discussed above, the rate model setup interface 260 may include progress tabs 262, 264, and 266. As illustrated, the progress tab 264 may have a corresponding organization panel 282 and a window 284. The organization panel 282 may include selectable features 286, 288, 290, 292, and 294 that a user may interact with to select attributes associated with a rate model, which are displayed in the window 284. Additionally, the user may determine an arrangement of the selected attributes from the organization panel 282. In some embodiments, the arrangement may relate to the order at which the resource attributes 178 are compared, as discussed herein.

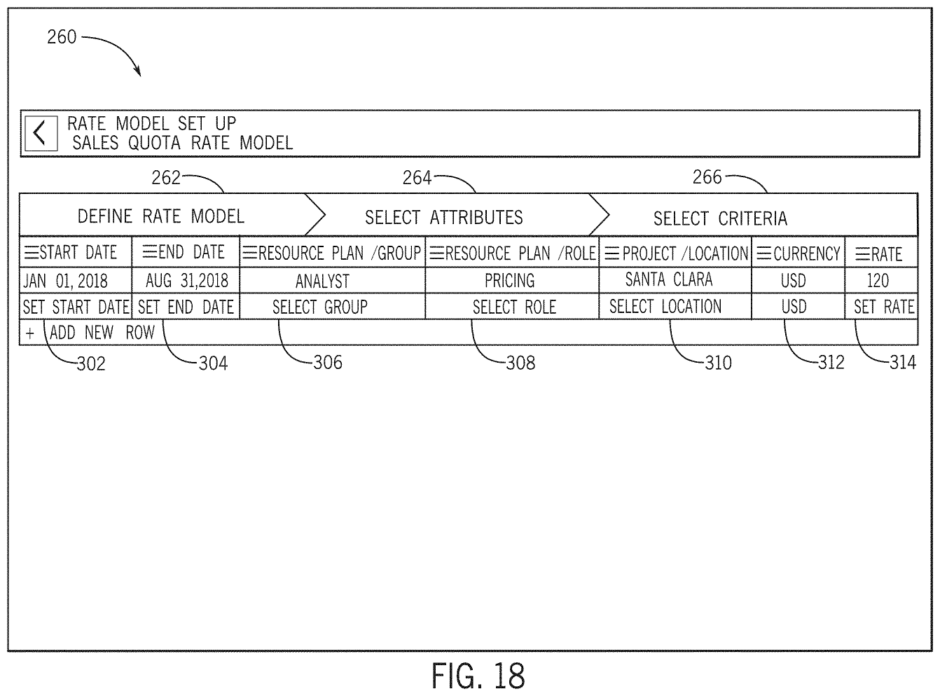

FIG. 18 is a screenshot of an additional embodiment of the rate model setup interface 260 shown in FIG. 16, in accordance with aspects of the present disclosure. As discussed above, the rate model setup interface 260 may include progress tabs 262, 264, and 266. As illustrated, the progress tab 266 may have a corresponding window 300, which includes multiple fields 302, 304, 306, 308, 310, 312, and 314 for a user to fill out that relate the resource availability data and resource attribute data.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . . ” or “step for [perform]ing [a function]. . . ”, it is intended that such elements are to be interpreted under 35 U.S.C. 112(f). However, for any claims containing elements designated in any other manner, it is intended that such elements are not to be interpreted under 35 U.S.C. 112(f).

1. A system for outputting one or more resource allocation records that include date-effective rates for a specific set of criteria in a rate request, comprising:
a client instance hosted by one or more data centers, wherein the client instance is accessible by one or more remote client networks, wherein the system is configured to perform operations comprising:
receiving a rate request comprising a resource plan time range and one or more resource attributes;
retrieving a resource table from one or more databases accessible by the client instance, wherein each record of the resource table comprises resource availability data, one or more resource attribute data, and a rate;
identifying one or more candidate records of the resource table based at least in part on a comparison between the resource plan time range of the rate request and the resource availability data of each record of the resource table;
outputting one or more resource allocation records based at least in part on the resource plan time range and a rate of at least one candidate record or a subset of the one or more candidate records; and
displaying the one or more resource allocation records on a user interface of the system.

2. The system of claim 1, wherein the subset of the one or more candidate records are based at least in part on a comparison between the one or more resource attributes of the one or more resource attributes and the resource attribute data of each record of the resource table.

3. The system of claim 2, wherein identifying the subset of the one or more candidate records comprises:
identifying a first portion of the one or more candidate records that do not include data related to a first resource attribute of the one or more resource attributes;
identifying a second portion of the one or more candidate records that includes an “all-others” attribute in a field related to the first resource attribute; and
identifying the second portion as the subset of the one or more candidate records.

4. The system of claim 1, wherein at least one of the one or more resource attributes are indicative of a type of currency.

5. The system of claim 1, wherein identifying the one or more candidate records of the resource table comprises identifying a first candidate record that overlaps with at least a first portion of the resource plan time range.

6. The system of claim 5, wherein identifying the one or more candidate records of the resource table comprises identifying a second candidate record that overlaps with at least a second portion of the resource plan time range.

7. The system of claim 1, wherein the one or more candidate records are a default resource record when the resource plan time range of the rate request does not overlap with the resource availability data of each record of the resource table.

8. The system of claim 1, wherein the rate request comprises a resource plan, a project, a task, or a time card.

9. The system of claim 1, wherein at least one resource attribute of the one or more resource attributes is related to a location of the resource, a role of the resource, or a group of the resource.

10. The system of claim 1, wherein outputting the one or more resource allocation records comprises arranging the subset of the one or more candidate records based on a financial period of the enterprise.

11. A method for outputting one or more resource allocation records that include date-effective rates for a specific set of criteria in a rate request, comprising:
receiving a rate request, wherein the rate request comprises a resource plan time range and one or more resource attributes;
retrieving a resource table from one or more databases accessible by the client instance, wherein each record of the resource table comprises resource availability data, one or more resource attribute data, and a rate;
identifying one or more candidate records of the resource table based at least in part on a comparison between the resource plan time range of the rate request and the resource availability data of each record of the resource table;
identifying a subset of the one or more candidate records based at least in part on a comparison between the one or more resource attributes of the one or more resource attributes and the resource attributes of each record of the resource table;
outputting one or more resource allocation records based at least in part on the resource plan time range and a rate of at least one record from the subset of the one or more candidate records; and
displaying the one or more resource allocation records on a user interface.

12. The method of claim 11, wherein outputting the one or more resource allocation records comprises arranging the subset of the one or more candidate records based on a financial period of the enterprise.

13. The method of claim 11, wherein outputting the one or more resource allocation records based at least in part on the resource plan time range and the rate of the at least one record from the subset of the one or more candidate records comprises:
identifying a first candidate record of the subset of the one or more candidate records that overlaps with a first portion of the resource plan time range;
identifying a second candidate record of the subset of the one or more candidate records that overlaps with a second portion of the resource plan time range; and
outputting at least one resource record of the one or more resource records based on a first rate of the first candidate record and the first portion of the resource plan time range, and a second rate of the second candidate record and the second portion of the resource plan time range.

14. The method of claim 11, wherein outputting the one or more resource allocation records based at least in part on the resource plan time range and the rate of the at least one record from the subset of the one or more candidate records comprises:
identifying a first candidate record of the subset of the one or more candidate records that has a first rate that is less than a second rate of a second candidate record of the subset of the one or more candidate records; and
identifying the first rate as the rate.

15. The method of claim 11, wherein the one or more candidate records are a default resource record when the resource plan time range of the rate request does not overlap with the resource availability data of each record of the resource table.

16. The method of claim 11, comprising:
identifying the one or more candidate records of the resource table based at least in part on the comparison between the one or more resource attributes of the rate request and the resource attributes of each record of the resource table;
identifying the subset of the one or more candidate records based at least in part on the comparison between the resource plan time range of the rate request and the resource availability data of each record of the resource table.

17. The method of claim 11, wherein identifying the subset of the one or more candidate records comprises:
identifying a first portion of the one or more candidate records that do not include data related to a first resource attribute of the one or more resource attributes;
identifying a second portion of the one or more candidate records that includes an “all-others” attribute in a field related to the first resource attribute; and
identifying the second portion as the subset of the one or more candidate records.

18. A tangible, non-transitory, machine-readable medium, comprising machine-readable instructions, wherein the machine-readable instructions, when executed by one or more processors cause the one or more processors to:
receive a rate request, wherein the rate request comprises a resource plan time range and one or more resource attributes;
retrieve a resource table from one or more databases accessible by the client instance, wherein each record of the resource table comprises resource availability data, one or more resource attribute data, and a rate;
identify one or more candidate records of the resource table based at least in part on a comparison between the resource plan time range of the rate request and the resource availability data of each record of the resource table;
identify a subset of the one or more candidate records based at least in part on a comparison between the one or more resource attributes of the one or more resource attributes and the resource attribute data of each record of the resource table;
output one or more resource allocation records based at least in part on the resource plan time range and a rate of at least one record from the subset of the one or more candidate records; and
display the one or more resource allocation records on a user interface.

19. The tangible, non-transitory, machine-readable medium of claim 18, comprising outputting the one or more resource allocation records based on an arrangement the subset of the one or more candidate records related to a financial period of the enterprise.

20. The tangible, non-transitory, machine-readable medium of claim 18, wherein identifying the subset of the one or more candidate records comprises:
identifying a first portion of the one or more candidate records that do not include data related to a first resource attribute of the one or more resource attributes;
identifying a second portion of the one or more candidate records that includes an “all-others” attribute in a field related to the first resource attribute; and
identifying the second portion as the subset of the one or more candidate records.
